(19) United States
(12) Patent Application Publication
(10) Pub. No.: US 2021/0329915 A1
(43) Pub. Date: Oct. 28, 2021

(54) ABSORPTION PROMOTER, FLYING-INSECT PEST REPELLENT FRAGRANCE-CONTAINING COMPOSITION, AND FLYING-INSECT PEST REPELLENT PRODUCT

(71) Applicant: DAINIHON JOCHUGIKU Co., Ltd., Osaka (JP)

(72) Inventors: Ryoko UKITA, Osaka (JP); Tomomi IWAMOTO, Osaka (JP); Taiji ONO, Osaka (JP); Yumi KAWAJIRI, Osaka (JP); Koji NAKAYAMA, Osaka (JP)

(21) Appl. No.: 17/273,825

(22) PCT Filed: Sep. 18, 2019
(86) PCT No.: PCT/JP2019/036600

§ 371 Date: Mar. 5, 2021

(30) Foreign Application Priority Data
Sep. 19, 2018 (JP) 2018-174783
Apr. 26, 2019 (JP) 2019-085502
Sep. 9, 2019 (JP) PCT/JP2019/035301

(51) Int. Cl. A01N 25/18; A01N 25/34; A01N 25/10; A01N 25/24; A01N 37/02; A01N 37/10; A01N 31/16; A01N 31/06; A01N 31/02; A01N 35/02; A01N 65/44; A01N 65/28; A01N 31/14; A01P 17/00

(52) U.S. Cl. CPC A01N 25/18; A01N 25/34; A01N 25/10; A01N 25/24; A01N 37/02; A01N 37/10; A01P 17/00; A01N 31/06; A01N 31/02; A01N 35/02; A01N 65/44; A01N 65/28; A01N 31/14; A01N 31/16

(57) ABSTRACT

Provided is an absorption promotor for causing a flying-insect pest repellent fragrance-containing composition with a high repellent effect to be rapidly absorbed into an elastomer molded body. The absorption promotor for causing a flying-insect pest repellent fragrance-containing composition into an elastomer molded body having a hardness of 60 degrees or less includes d-limonene and/or 1,8-cineole as an active ingredient. The absorption promotor is blended preferably in a range of 2.0 to 65% by mass and more preferably 10 to 45% by mass in the flying-insect pest repellent fragrance-containing composition.

### TECHNICAL FIELD

The present invention relates to an absorption promotor for causing a flying-insect pest repellent fragrance-containing composition to be absorbed into an elastomer molded body having a hardness of 60 degrees or less, a flying-insect pest repellent fragrance-containing composition, and a flying-insect pest repellent product.

### BACKGROUND ART

Conventionally, a method of applying a repellent containing DEET (N,N-diethyltoluamide) to the skin surface is commonly used against flying-insect pests, such as mosquitoes, gnats, chironomids, and flies. However, DEET is not expected to have a spatial repellent effect because its volatility is somewhat low, compared to ordinary fragrance components. On the other hand, room-temperature volatile insecticidal components, such as pyrethroid-based empenthrin, are volatized into a space to achieve a repellent effect on flying-insect pests, but there are not a few situations where room-temperature volatile insecticidal components are discouraged from being used.

Therefore, several attempts have been proposed to use volatile natural essential oils and their compositional components as repellent components. For example, it is well known that citronella oil and citronellal as its main component have repellent effects on mosquitoes, and candles containing citronella oil as an active ingredient are commercially available in the United States. However, a method of dissipating citronellal by using heat of the candle is less efficient in volatilizing citronellal and does not exhibit a practical repellent effect.

Japanese Unexamined Patent Publication No. 2002-173407 (Patent Document 1) describes flying-insect pest repellents that contain, as an active ingredient, natural essential oil selected from orange oil, cassia oil, etc., in addition to citronella oil. As a solvent for use in a solution, various solvents are exemplified, including alcohols such as methyl alcohol and ethyl alcohol, esters such as diethyl phthalate and isopropyl myristate, aliphatic hydrocarbons such as hexane, kerosene and paraffin, aromatic hydrocarbons, ethers, and the like.

In addition, Japanese Unexamined Patent Application Publication No. 2003-201203 (Patent Document 2) discloses a volatile insect pest repellent composition that includes citronellal and one or more element selected from terpineol, menthol, limonene, geraniol, citronellol, and camphene, as an insect pest repellent component (A), wherein the content of citronellal in the insect pest repellent component (A) is 2 to 10% by mass. However, these repellents claim to be natural-oriented and considered safe, but their repellent effects are inferior in persistence and not necessarily satisfactory.

Further, Japanese Unexamined Patent Application Publication No. S61-289002 (Patent Document 3) has proposed a “repellent for arthropods, mollusks, and reptiles, which contains a glycol ether as an active ingredient”. Patent Document 3 describes that glycol ethers have an excellent repellent effect on cockroaches and mites, but its effect is far from sufficient, and furthermore no mention is made on the repellent effect on flying-insect pests.

Thus, no useful compound or composition is known that aims to improve the persistence of aromas, in addition to the flying-insect pest repellent effect, and the development of such a compound and composition has been required.

The term elastomer refers to a source/material with rubber elasticity. Elastomers are classified into “thermosetting elastomers”, typified by silicone rubber, which are not softened when heated, and “thermoplastic elastomers”, which are softened when heated but return to a rubber state when cooled. Both thermosetting elastomers and thermoplastic elastomers are known to have excellent adsorption and gas permeability, as well as stable physical properties and excellent fragrance dispersion. By taking advantages of these properties, air fresheners containing fragrances in various elastomers are commercially available, but they still have many points to be improved.

The following is concerned with, for example, silicone rubber molded products. In a general process of causing a fragrance to be contained in a silicone rubber, the fragrance is usually mixed with a silicone compound or a composition containing a liquid silicone polymer and then vulcanized (cross-linked) by using a reaction aid made of sulfur, platinum, etc., an additive, or the like. However, when kneaded, the fragrance tends to separate from the silicone polymer or additive, which further causes chemical changes, such as decomposition and modification of the fragrance, due to the reaction aid and heat generated during molding. As a result, this makes it difficult to obtain a molded product with aromaticity and stable physical properties.

As a means of solving such problems, in Japanese Unexamined Patent Application Publications No. H8-311216 (Patent Document 4) and No. 2011-26462 (Patent Document 5), a method of adding a fragrance after molding a silicone rubber is employed instead of kneading a fragrance before molding a silicone rubber. The flying-insect pest repellent product using such a silicone rubber molded body is required to allow a composition containing a flying-insect pest repellent fragrance with a high repellent effect to be rapidly absorbed in a liquid state into the silicone rubber molded body. Further, the flying-insect pest repellent product is also required to support the flying-insect pest repellent fragrance in the silicone rubber molded body without decomposition and deterioration during storage as the product, thus enabling this fragrance to be effectively volatized in use. However, these patent documents have never mentioned the properties of the fragrance composition and its compatibility with the silicone rubber molded body.

### CITATION LIST

### Patent Literature

Patent Document 1: Japanese Unexamined Patent Application Publication No. 2002-173407

Patent Document 2: Japanese Unexamined Patent Application Publication No. 2003-201203

Patent Document 3: Japanese Unexamined Patent Application Publication No. S61-289002

Patent Document 4: Japanese Unexamined Patent Application Publication No. H8-311216

Patent Document 5: Japanese Unexamined Patent Application Publication No. 2011-26462

### SUMMARY OF INVENTION

### Technical Problem

Thus, in developing useful flying-insect pest repellent products utilizing an elastomer molded body such as a silicone rubber molded body, it is essential to select a flying-insect pest repellent fragrance with a high repellent effect, but it is also essential to carry out various tests repeatedly by trial and error after finding an absorption promotor for promoting absorption of a flying-insect pest repellent fragrance and a compound or composition having excellent compatibility with the elastomer molded body.

With the above problems in mind, the present invention has been made. It is an object of the present invention to provide an absorption promotor for causing an elastomer molded body to absorb a composition containing a flying-insect pest repellent fragrance with a high repellent effect (hereinafter referred to as a “flying-insect pest repellent fragrance-containing composition”), as well as a flying-insect pest repellent fragrance-containing composition and a flying-insect pest repellent product that exhibits the excellent flying-insect pest repellent effect in use by suppressing the decomposition and deterioration of the flying-insect pest repellent fragrance during storage as the product.

### Solution To Problem

The present invention has been made based on findings that the following configurations exhibit excellent effects in achieving the above object.

(1) An absorption promotor for causing a flying-insect pest repellent fragrance-containing composition to be absorbed into an elastomer molded body having a hardness of 60 degrees or less, including

d-limonene and/or 1,8-cineole as an active ingredient.

(2) The absorption promotor of (1), wherein the elastomer molded body is a silicon rubber molded body.

(3) The absorption promotor of (1), wherein the elastomer molded body is a thermoplastic elastomer molded body.

(4) The absorption promotor of (3), wherein the thermoplastic elastomer molded body is a styrene-based thermoplastic elastomer molded body or an olefin-based thermoplastic elastomer molded body.

(5) The absorption promotor of any one of (1) to (4), wherein the absorption promotor is blended in a range of 2.0 to 65% by mass in the flying-insect pest repellent fragrance-containing composition.

(6) The absorption promotor of (5), wherein the absorption promotor is blended in a range of 10 to 45% by mass in the flying-insect pest repellent fragrance-containing composition.

(7) The absorption promotor of any one of (1) to (6), wherein the flying-insect pest repellent fragrance-containing composition contains the following component (a) and component (b),

the component (a) being an acetate compound as a single substance or a mixture, represented by general formula (I) below,

CH₃—COO—R1 (I)

wherein R1 is an alcohol residue having 6 to 12 carbon atoms,

the component (b) being a monoterpene-based alcohol and/or an aromatic alcohol having 10 carbon atoms.

(8) The absorption promotor of (7), wherein the component (a) is at least one selected from the acetate compound and an allyl ester compound as a single substrate or a mixture, represented by general formula (II) below,

R2—CH₂—COO—CH₂—CH═CH₂ (II)

wherein R2 is an alkyl, alkoxy, cycloalkyl, cycloalkoxy, or phenoxy group having 4 to 7 carbon atoms.

(9) The absorption promotor of (7) or (8), wherein a blending ratio of the component (a) to the component (b) in the flying-insect pest repellent fragrance-containing composition is set in a range of 0.2 to 2.0 times.

(10) The absorption promotor of any one of (7) to (9), wherein the acetate compound is at least one selected from the group consisting of: p-tert-butylcyclohexyl acetate, o-tert-butylcyclohexyl acetate, p-tert-pentylcyclohexyl acetate, tricyclodecenyl acetate, benzyl acetate, phenylethyl acetate, styralyl acetate, anisyl acetate, menthyl acetate, cinnamyl acetate, terpinyl acetate, dihydroterpinyl acetate, linalyl acetate, ethyl linalyl acetate, citronellyl acetate, geranyl acetate, neryl acetate, bornyl acetate, and isobornyl acetate.

(11) The absorption promotor of any one of (8) to (10), wherein the allyl ester compound is at least one selected from the group consisting of allyl hexanoate, allyl heptanoate, allyl octanoate, allyl n-amyl oxyacetate, allyl cyclohexyl acetate, allyl cyclohexyl oxyacetate, and allyl phenoxyacetate.

(12) The absorption promotor of any one of (7) to (11), wherein the monoterpene-based alcohol and/or the aromatic alcohol having 10 carbon atoms is at least one selected from the group consisting of terpineol, geraniol, dihydromyrcenol, borneol, menthol, citronellol, nerol, linalool, ethyl linalool, thymol, eugenol, and p-menthane-3,8-diol.

(13) The absorption promotor of any one of (7) to (12), wherein the flying-insect pest repellent fragrance-containing composition further contains a glycol and/or a glycol ether having a vapor pressure of 0.2 to 20 Pa at 20° C., as a repellant effect persistence component when a flying-insect pest repellent fragrance is volatilized.

(14) The absorption promotor of (13), wherein the glycol and/or the glycol ether is at least one selected from the group consisting of benzyl glycol, propylene glycol, dipropylene glycol, tripropylene glycol, 1,3-butylene glycol, hexylene glycol, diethylene glycol monobutyl ether, dipropylene glycol monobutyl ether, and tripropylene glycol monomethyl ether.

(15) A flying-insect pest repellent fragrance-containing composition, comprising: a component (a) and a component (b); and d-limonene and/or 1,8-cineole,

the component (a) being an acetate compound as a single substance or a mixture, represented by general formula (I) below,

CH₃—COO—R1 (I)

wherein R1 is an alcohol residue having 6 to 12 carbon atoms,

the component (b) being a monoterpene-based alcohol and/or an aromatic alcohol having 10 carbon atoms.

(16) The flying-insect pest repellent fragrance-containing composition of (15), wherein

the component (a) is at least one selected from the acetate compound and an allyl ester compound as a single substrate or a mixture, represented by general formula (II) below,

R2—CH₂—COO—CH₂—CH═CH₂ (II)

wherein R2 is an alkyl, alkoxy, cycloalkyl, cycloalkoxy, or phenoxy group having 4 to 7 carbon atoms.

(17) A flying-insect pest repellent product, comprising a flying-insect pest repellent fragrance-containing composition in which the absorption promotor according to any one of claims 1 to 14 is blended, the flying-insect pest repellent fragrance-containing composition being held on an elastomer molded body while being embedded in interstices of a molecular structure of the elastomer molded body, the elastomer molded body having a hardness of 60 degrees or less.

(18) The flying-insect pest repellent product of (17), wherein the elastomer molded body having the hardness of 60 degrees or less is configured such that a flying-insect pest repellent fragrance is volatilized from a surface of the elastomer molded body at a rate (average volatilization amount per unit surface area) of 0.04 to 0.9 mg/cm²·h.

(19) The flying-insect pest repellent product of (17) or (18), wherein the elastomer molded body having the hardness of 60 degrees or less is a ring-shaped elastomer molded body that includes a stretchable ring-shaped portion which a part of a human body or an object is inserted into or attached to, or a band-shaped elastomer molded body which is capable of forming a stretchable ring-shaped portion by connecting or proximating ends and which a part of a human body or an object is inserted into or attached to.

(20) The flying-insect pest repellent product of (19), wherein the flying-insect pest repellent fragrance is volatilized over 5 to 15 hours while the part of the human body or object is inserted into or attached to the ring-shaped portion.

### EFFECTS OF INVENTION

The absorption promotor of the present invention provides the flying-insect pest repellent fragrance-containing composition having excellent compatibility with the elastomer molded body. That is, the flying-insect pest repellent fragrance-containing composition containing the flying-insect pest repellent fragrance with a high repellent effect is rapidly absorbed into the elastomer molded body, while the flying-insect pest repellent fragrance is supported on the elastomer molded body without decomposition and deterioration during storage as the product, thereby allowing this fragrance to be effectively volatilized in use. Therefore, the flying-insect pest repellent fragrance-containing composition in which the absorption promotor is blended and the flying-insect pest repellent product using the flying-insect pest repellent fragrance-containing composition according to the present invention exhibit excellent flying-insect pest repellent effects for a predetermined period of time, and thus they are extremely practical.

The use of the aromatic component as the flying-insect pest repellent fragrance can exert the effect of maintaining the initial fragrance tone for a long period of time.

### DESCRIPTION OF EMBODIMENTS

Hereinafter, as embodiments regarding an absorption promotor, a flying-insect pest repellent fragrance-containing composition, and a flying-insect pest repellent product of the present invention, a description will be given on an absorption promotor for causing a liquid, flying-insect pest repellent fragrance-containing composition to be absorbed into an elastomer molded body, as well as a flying-insect pest repellent product using the flying-insect pest repellent fragrance-containing composition in which this absorption promotor is blended. Note that the present invention is not intended to be limited to the configurations described in embodiments below.

In the flying-insect pest repellent product of the present invention, the flying-insect pest repellent fragrance-containing composition that contains the flying-insect pest repellent fragrance and the absorption promotor is held on an elastomer molded body having a hardness of 60 degrees or less and preferably 50 degrees or less while being embedded in interstices of the molecular structure of the elastomer molded body. A specific type of flying-insect pest repellent fragrance suitable for the elastomer molded body is used. Details of the flying-insect pest repellent fragrance will be given below.

The elastomer used in the molded body has properties, including excellent gas permeability, stable physical properties, and excellent absorption and dispersion of the fragrance. This is considered to be because the molecular structure of the fragrance is composed of carbons in the main chain, so that fragrance molecules can be easily embedded into the interstices of the molecular structure of the elastomer. In order to take advantage of the properties of the elastomer, it is preferable to adjust the hardness of the elastomer molded body to 60 degrees or less, and preferably 50 degrees or less. For example, an elastomer having a hardness of 60 degrees or less is used as a raw material for the elastomer molded body. Consequently, the hardness of the completed elastomer molded body also becomes 60 degrees or less. If the hardness of the elastomer molded body is 60 degrees or less, the molecular structure of the elastomer does not become too dense, thus allowing fragrance molecules to be easily embedded into the interstices of the molecular structure of the elastomer. The hardness of the elastomer molded body is measured by a method or device in conformity with the Japanese Industrial Standards (JIS K6253). In the present invention, the hardness of the elastomer molded body is measured by using a durometer that conforms to the above standard.

Elastomers are classified into “thermosetting elastomers”, typified by silicone rubber, and “thermoplastic elastomers”, which are softened when heated but return to a rubber state when cooled. Although both thermosetting elastomers and thermoplastic elastomers are applicable to the present invention, silicone rubber, which is a thermosetting elastomer, can be easily used in consideration of the manufacturability as the flying-insect pest repellent product, the absorption and dispersion of the fragrance, and the like.

Any type of silicone rubbers can be used, including a room-temperature curing type, a heat-curing type, a condensation type, an addition type, and the like. Normally, a silicone compound or liquid silicone polymer is vulcanized (cross-linked) using a reaction aid such as sulfur and platinum, an additive, and the like to prepare a silicone rubber molded body. By adjusting the cross-link density of the silicone rubber or the amount of addition of silicone oil or filler used as the additive, the volatilization amount of the flying-insect pest repellent fragrance-containing composition to be added later can be controlled.

The silicone rubber molded body used in the present invention may contain other types of elastomers. For example, a silicon rubber molded body containing a fluorine-based rubber in addition to the silicone rubber is expected to have improved durability.

On the other hand, a thermoplastic elastomer (TPE) is generally composed of a flexible component (soft segment) that exhibits rubber elasticity and a molecularly constrained component (hard segment) that flows at high temperatures but prevents deformation of the elastomer at room temperature. Thermoplastic elastomers include a block copolymer type in which both components form a block copolymer and a blend type in which both components are physically dispersed. Thermoplastic elastomers are classified into types of a styrene-based TPE (TPS), an olefin-based TPE (TPO), an ester-based TPE (TPEE), an urethane-based TPE (TPU), an amide-based TPE (TPA), etc., depending on the combination of soft and hard segments. Although all of these thermoplastic elastomers are applicable to the present invention, the use of styrene-based TPE (TPS) and olefin-based TPE (TPO) is preferable in order to suppress the decomposition and deterioration of the flying-insect pest repellent fragrance during storage as the product and to exhibit an excellent flying-insect pest repellent effect in use. Examples of TPS include styrene-butadiene-styrene block copolymer (SBS), styrene-isoprene-styrene block copolymer (SIS), styrene-ethylene butylene-styrene block copolymer (SEBS), and the like. Typical TPOs include, but are not limited to, TPO or TPO-V, each including ethylene-propylene-diene rubber (EPDM) as a soft segment and polypropylene (PP) as a hard segment.

The present invention is characterized in that d-limonene and/or 1,8-cineole is blended as the absorption promotor in the flying-insect pest repellent fragrance-containing composition in order for the flying-insect pest repellent fragrance-containing composition to be rapidly absorbed in a liquid state into the elastomer molded body when the flying-insect pest repellent fragrance-containing composition is supported onto the elastomer molded body. Such an absorption promotor contributes to the stabilization of the flying-insect pest repellent fragrance in the elastomer molded body after the liquid absorption and further the effective volatilization performance in use.

While the above-mentioned d-limonene and/or 1,8-cineole is known to show a flying-insect pest repellent effect on certain occasions, it is a novel finding which is worth noting that they are useful as absorption promoters in flying-insect pest repellent products utilizing an elastomer molded body. That is, according to the results of an intensive investigation conducted by the inventors, by blending the absorption promotor having excellent compatibility with the elastomer molded body, the flying-insect pest repellent fragrance-containing composition is rapidly absorbed in a liquid state into the elastomer molded body and thus held in the interstices of the molecular structure of the elastomer molded body. This significantly reduces the risk of the decomposition and deterioration of a certain flying-insect pest repellent fragrance remaining on the surface of the elastomer molded body, which clearly shows that its effects, such as the stability of products during storage and volatilization performance in use, could be enhanced in a collaborative manner.

On the other hand, the absorption of the flying-insect pest repellent fragrance-containing composition in a liquid state can be promoted only by adding an organic solvent, but this method could be found to have some effects on the stability of the flying-insect pest repellent fragrance thereafter during storage as the product or the volatilization performance thereof in use, which is not preferable.

The blending amount of the above-mentioned absorption promoter in the flying-insect pest repellent fragrance-containing composition is preferably in the range of 2.0 to 65% by mass, and more preferably 10 to 45% by mass. If the blending amount is less than 2.0% by mass, the flying-insect pest repellent fragrance-containing composition cannot obtain a sufficient liquid-absorption promoting effect. On the other hand, if the blending amount is more than 65% by mass, it is not preferable because this absorption promotor may interfere with the flying-insect pest repellent effect of the flying-insect pest repellent fragrance.

The flying-insect pest repellent fragrance-containing composition used in the flying-insect pest repellent product of the present invention uses a fragrance component as the flying-insect pest repellent component without substantially using an insecticidal component. Such a fragrance component is referred to as a “flying-insect pest repellent fragrance”. The flying-insect pest repellent fragrance contained in the flying-insect pest repellent fragrance-containing composition contains the following components (a) and (b).

The component (a) is, for example, an acetate compound as a single substance or a mixture, represented by general formula (I):

CH₃—COO—R1 (I)

wherein R1 is an alcohol residue having 6 to 12 carbon atoms.

The component (b) is, for example, a monoterpene-based alcohol and/or an aromatic alcohol having 10 carbon atoms.

In the flying-insect pest repellent fragrance, the component (a) can further contain an allyl ester compound as a single substance or a mixture, represented by general formula

R2—CH₂—COO—CH₂—CH═CH2 (II)

wherein R2 is an alkyl, alkoxy, cycloalkyl, cycloalkoxy, or phenoxy group having 4 to 7 carbon atoms. In this case, the component (a) is at least one selected from the acetate compound and the allyl ester compound.

The flying-insect pest repellent fragrance will be described more specifically, wherein this fragrance is contained in the flying-insect pest repellent fragrance-containing composition, which is used in the flying-insect pest repellent product of the present invention.

Specific examples of the acetate compound represented by the general formula (I), which is the component (a) of the flying-insect pest repellent fragrance, include p-tert-butylcyclohexyl acetate, o-tert-butylcyclohexyl acetate, p-tert-pentylcyclohexyl acetate, tricyclodecenyl acetate, benzyl acetate, phenylethyl acetate, styralyl acetate, anisyl acetate, menthyl acetate, cinnamyl acetate, terpinyl acetate, dihydroterpinyl acetate, linalyl acetate, ethyl linalyl acetate, citronellyl acetate, geranyl acetate, neryl acetate, bornyl acetate, isobornyl acetate, and the like. These acetate compounds may be used alone, or two or more of them may be used in any combination.

Specific examples of the allyl ester compound represented by the general formula (II), which is the component (a) of the flying-insect pest repellent fragrance, include allyl hexanoate, allyl heptanoate, allyl octanoate, allyl isobutyl oxyacetate, allyl n-amyl oxyacetate, allyl cyclohexyl acetate, allyl cyclohexyl propionate, allyl cyclohexyl oxyacetate, allyl phenoxyacetate, and the like. These allyl ester compounds may be used alone, or two or more of them may be used in any combination. Further, these allyl ester compounds can also be used in any combination with the above-mentioned acetate compound.

Specific examples of the monoterpene-based alcohol and/or aromatic alcohol having 10 carbon atoms, which is the component (b) of the flying-insect pest repellent fragrance, include terpineol, terpinen-4-ol, geraniol, dihydromyrcenol, borneol, menthol, citronellol, nerol, linalool, ethyl linalool, thymol, eugenol, p-menthane-3,8-diol, and the like. These monoterpene-based alcohol and/or aromatic alcohol having 10 carbon atoms may be used alone, or two or more of them may be used in any combination.

In the flying-insect pest repellent product of the present invention, a combination of the component (a) and the component (b) is preferably used as the flying-insect pest repellent fragrance. In this case, the inventors have confirmed through their intensive investigation that particularly by setting the blending ratio of the component (a) to the component (b) to 0.2 to 2.0 times, an excellent flying-insect pest repellent result can be obtained.

In the flying-insect pest repellent product of the present invention, fragrance components other than those described above may be added as the flying-insect pest repellent fragrance as needed. Example of other fragrance components include compounds such as α-pinene, β-pinene, carvone, pulegone, camphor and damascone, monoterpene-based aldehydes such as citral, citronellal, neral and perillaldehyde, other ester compounds such as benzyl benzoate, cinnamylformate, and geranyl formate, phenylethyl alcohol, diphenyl oxide, vanillin, jasmine lactone, and indole aroma.

Furthermore, various essential oils containing the above-mentioned fragrance components, such as jasmine oil, neroli oil, peppermint oil, bergamot oil, orange oil, geranium oil, petitgrain oil, lemon oil, citronella oil, lemongrass oil, cinnamon oil, eucalyptus oil, lemon eucalyptus oil, thyme oil, and ghetto oil may be added as appropriate.

In the present invention, even when an essential oil is blended, if the content of the absorption promotor or flying-insect pest repellent fragrance in the essential oil is 2.0% by mass or more, the essential oil is defined as being blended as the individual absorption promoter or flying-insect pest repellent fragrance.

The flying-insect pest repellent fragrance-containing composition used in the present invention preferably further contains a glycol and/or a glycol ether having a vapor pressure of 0.2 to 20 Pa at 20° C., as a repellant effect persistence component when volatilizing the flying-insect pest repellent fragrance.

Such glycols and/or glycol ethers are listed as solvents which are in the same category as ethanol, isopropanol, kerosene and the like in Patent Document 2. In Patent Document 3, they are described as exhibiting an excellent repellent effect on cockroaches and mites, but the effects on flying-insect pests are not mentioned at all. Thus, the inventors have found that glycols and/or glycol ethers act not only as solvents, but also can exhibit lasting efficacy of the specific repellent effect of the flying-insect pest repellent fragrance and also maintain the initial fragrance tone in the case of using the aromatic flying-insect pest repellent fragrance.

Specific examples of the glycol and/or glycol ether described above (with the vapor pressure at 20° C.) include propylene glycol (10.7 Pa), dipropylene glycol (1.3 Pa), tripropylene glycol (0.67 Pa), diethylene glycol (3 Pa), triethylene glycol (1 Pa), 1,3-butylene glycol, hexylene glycol (6.7 Pa), benzyl glycol (2.7 Pa), diethylene glycol monobutyl ether (3 Pa), dipropylene glycol monobutyl ether, and tripropylene glycol monomethyl ether, of which dipropylene glycol is suitable for the purpose of the present invention. The above-mentioned glycols and/or glycol ethers may be used alone, or two or more of them may be used in any combination. The appropriate blending ratio of the glycol and/or glycol ether to the flying-insect pest repellent fragrance is about 0.05 to 5 times.

The flying-insect pest repellent fragrance-containing composition may contain other functional components as long as they do not interfere with the effects of the present invention. Other functional components include, for example, an insecticidal component, a deodorizing component, bactericidal and antibacterial components, and the like. Examples of the insecticidal component include empenthrin, profluthrin, transfluthrin, metofluthrin, and the like, which are based on room-temperature volatile pyrethroids. When blending the insecticidal component, it is preferable to limit the amount of the insecticidal component to as small an amount as possible in light of the gist of the present invention. Typical deodorizing components are plant extracts selected from the grass family, Theaceae, Ginkgoaceae, Oleaceae, Moraceae, Rutaceae, Malpighiaceae, and Ebenaceae. A leaf alcohol, a leaf aldehyde or the like called “the fragrance of green” can also be added to provide a relaxing effect. These functional components may be used alone or in any combination.

The flying-insect pest repellent fragrance-containing composition may contain a solvent, a surfactant, a solubilizer, a dispersant, a stabilizing agent, a pH adjuster, a colorant, and the like as long as they do not interfere with the purpose and effects of the flying-insect pest repellent product of the present invention. Alternatively, the flying-insect pest repellent fragrance-containing composition is subjected to, for example, microencapsulating or cyclodextrinizing, thereby making it possible to stabilize the flying-insect pest repellent fragrance-containing composition and adjust the volatilizing property of the flying-insect pest repellent fragrance.

Examples of the solvent used in the preparation of the flying-insect pest repellent product include water, lower alcohols such as ethanol and isopropanol, ketone-based solvents, ester-based solvents, and hydrocarbon solvents such as normal paraffin and isoparaffin. The surfactants include nonionic surfactants and higher alkylamine oxide surfactants. Examples of the nonionic surfactant include polyoxyethylene hydrogenated castor oil, polyoxyethylene higher alkyl ethers (such as polyoxyethylene lauryl ether and polyoxyethylene oleyl ether), polyoxyethylene alkylphenyl ethers, polyoxyethylene higher fatty acid esters, polyoxyethylene sorbitan fatty acid esters, polyoxyethylene glycerin fatty acid esters, polyoxyethylene polyoxypropylene alkyl ethers, and the like. Examples of the higher alkylamine oxide surfactant include laurylamine oxide, stearylamine oxide, lauramidopropyldimethylamine oxide, and the like. These surfactants may be used alone or in any combination.

As a method for adding the flying-insect pest repellent fragrance-containing composition to the elastomer molded body, a conventionally known method can be employed as appropriate. For example, in a case where the surface area of the elastomer molded body is large, the flying-insect pest repellent fragrance-containing composition is supported onto the elastomer molded body by a chemical dispensing or coating method. In a case where the surface area of the elastomer molded body is small, a large number of elastomer molded bodies are placed in a sealed container, to which the flying-insect pest repellent fragrance-containing composition is added together with a solvent as necessary and then sprayed or dripped to penetrate the elastomer molded bodies. Furthermore, the flying-insect pest repellent product can also be manufactured by immersing the elastomer molded body in a liquid of the flying-insect pest repellent fragrance-containing composition for an appropriate period of time, or by mixing a high concentration of the elastomer molded body containing the flying-insect pest repellent fragrance-containing composition and an untreated elastomer molded body in a sealed container and then leaving them for an appropriate period of time to equalize the concentration of the flying-insect pest repellent fragrance-containing composition over the entire elastomer molded bodies.

The form and specifications of the elastomer molded body will be described below by taking a silicone rubber molded body as an example, but these can be applied to other elastomer molded bodies.

The silicone rubber molded body is configured to hold the flying-insect pest repellent fragrance-containing composition in the interstices of its molecular structure and volatilize the flying-insect pest repellent fragrance from its surface at a rate of 0.04 to 0.9 mg/cm²·h (average volatilization amount per unit surface area). In consideration of the fact that the absorption promoter of the present invention serves as the flying-insect pest repellent fragrance, the “volatilization amount of flying-insect pest repellent fragrance” in the present invention, which includes the volatilization amount of absorption promotor, is calculated. When an average volatilization amount of the flying-insect pest repellent fragrance is in this range, the bleeding of the flying-insect pest repellent fragrance inside the silicone rubber molded bodies proceeds stably and smoothly over a predetermined period of time. If the average volatilization amount of flying-insect pest repellent fragrance is less than 0.04 mg/cm²·h, the flying-insect pest repellent effect becomes insufficient. On the other hand, if the average volatilizatin amount of flying-insect pest repellent fragrance exceeds 0.9 mg/cm²·h, the duration of the repellent effect is shortened, or the holding amount of flying-insect pest repellent fragrance or flying-insect pest repellent fragrance-containing composition in the silicone rubber molded bodies becomes excessive, which makes it impossible for the surface not to become sticky. It is noted that the average volatilization amount of flying-insect pest repellent fragrance in the present invention was determined for averaging the volatilization amounts in a time section where the volatilization amount is greater than or equal to 0.02 mg/cm²·h.

The silicone rubber molded body can have various shapes, such as a ring shape, a band shape, or a small piece sheet shape. However, a ring-shaped silicone rubber molded body that includes a stretchable ring-shaped portion which a part of a human body or an object is inserted into or attached to, or a band-shaped silicone rubber molded body which is capable of forming a stretchable ring-shaped portion by connecting or proximating ends of a band and which a part of the human body or an object is inserted into or attached to are easy to use and suitable for the purpose of the present invention.

That is, when a ring-shaped silicone rubber molded body or a band-shaped silicone rubber molded body that holds the flying-insect pest repellent fragrance-containing composition is inserted into or attached to a part of the human body such as a wrist or ankle, or an object such as a handle of a buggy, a bicycle, etc., a handle of a bag, a backpack, a briefcase, etc., or a lace of a hat, a shoe, etc., the flying-insect pest repellent fragrance is gradually volatilized from the surface of the ring-shaped silicone rubber molded body or the band-shaped silicon rubber molded body, and continues to exhibit the frying-insect pest repellent effect over 5 to 15 hours and preferably 8 to 12 hours.

Alternatively, the ring-shaped silicone rubber molded body or the band-shaped silicone rubber molded body may be attached to a cover frame of a portable small fan or the like and used so that it is hit by the air from the fan. In this case, compared to the above-mentioned usage cases, the volatilization amount of flying-insect pest repellent fragrance is increased, and its effective duration is shortened, but it is possible to provide a flying-insect pest repellent product that can exhibit more excellent flying-insect pest repellent effects.

In the case of the ring-shaped silicone rubber molded body, a single cord-shaped body (with a wire diameter of 1 to 3 mm and a length of about 10 to 20 cm) with its peripheral parts connected together is used, and preferably such a single cord-shaped body is used so as to form a figure or character. Various figures or characters can be exemplified. Examples of them include, but are not limited to, animal series, insect series, vehicle series, alphabet series, and the like.

Here, while the figure or character formed from the single cord-shaped body configures a main portion, a branch portion that branches from one or several points of this cord-shaped body of the silicon rubber molded body may be formed to constitute an accessory. With this arrangement, decorativeness is given, and the weight of the silicone rubber molded body is increased, so that the amount of flying-insect pest repellent fragrance-containing composition held in the molded body can be increased, which results in the advantage that the number of flying-insect pest repellent products of the present invention to be attached onto the wrist, ankle, etc., can be decreased. The shape and size of the accessory are not limited as long as the volatility of the fragrance component in this portion is not too much or too little, compared to the figure or the main part of the character.

On the other hand, preferably, the band-shaped molded body has its size of about 0.5 to 2.0 cm in width, about 10 to cm in length, and about 1 to 3 mm in thickness, and is composed of parts overlapping each other, each part including at least one hollow and an outer portion surrounding the hollow. Here, it is confirmed that the hollow in each part generates diffused airflow and contributes to the improvement in volatility. For example, when the silicone rubber molded body is in a non-stretching state, the size of the hollow is preferably set to satisfy the following formula: 0.05 S₁/S₂≤0.6 where S₁ is the total area occupied by the hollows, and S₂ is the total area (including S₁) of the silicone rubber molded body in the planar view. If the value of S₁/S₂ is less than 0.05, the volatilization performance per unit weight of the silicon rubber molded body does not match that of the cord-shaped silicone rubber molded body. On the other hand, if the value of S₁/S₂ is greater than 0.6, there may be an issue with the strength of the silicone rubber molded body. The shape of the hollow can be configured so that its contour constitutes the figure or the shape of the character. As in the case of the cord-shaped molded body, various figures or character shapes can be exemplified in the band-shaped molded body. In addition, some of the hollows can be filled in and modified into a concave recessed shape. With this arrangement, the weight of the silicone rubber molded body can be increased while keeping the design of the hollows, thus making it possible to increase the amount of filling of the flying-insect pest repellent fragrance. Obviously, a branch portion that extends outwardly from the outer portion surrounding the hollow may be formed to thereby impart the character and design to the molded body.

The ring-shaped silicone rubber molded body or band-shaped silicone rubber molded body preferably expand and contract so as to form an attachment state in which, when a part of the molded body is expanded to make the molded body attached onto a wrist, ankle, etc., at least 20% and preferably 30% of the part is separated from the skin of the wrist, ankle, or the like. This is because the separated portion not only contributes to the improvement in the volatilizing property of the flying-insect pest repellent fragrance, but also can avoid the contact of even the fragrance component with the skin as much as possible, which is desirable.

In the case of the above-mentioned ring-shaped silicone rubber molded body or band-shaped silicone rubber molded body, the silicone rubber molded body itself may become a flying-insect pest repellent product as a wrist ring, a wrist band, or the like. On the other hand, the silicone rubber molded body having a small piece sheet shape may be prepared and combined with a plastic storage body which stores this molded body to constitute a flying-insect pest repellent product in the form of a watch band, for example. In this case, the silicone rubber molded body is freely replaceable and also has the advantage that it does not come into direct contact with the skin of the arm.

Such a combination of the silicone rubber molded body and the storage body can be obviously applied to various flying-insect pest repellent products, including not only those for human bodies, but also those for spaces inside vehicles or the like, such as those of an installation type and a suspended type, as long as the volatilization performance of the flying-insect pest repellent fragrance can be ensured to a predetermined extent.

The forms and specifications of the above-mentioned silicone rubber molded body can be applied to other elastomer molded bodies in the same way.

The blending amount of the flying-insect pest repellent fragrance-containing composition in the flying-insect pest repellent product of the present invention may be determined as appropriate depending on the usage purpose and usage duration of the flying-insect pest repellent product, the type and specfications of the elastomer molded body, and the like. For example, in the case of a flying-insect pest repellent product to be used for 5 to 15 hours and preferably 8 to 12 hours per usage time, it is preferable to blend about 20 to 200 mg of flying-insect pest repellent fragrance-containing composition in one elastomer molded body. In the case of a flying-insect pest repellent product to be used for 15 to 30 days, for example, it is preferable to blend about 100 to 2000 mg of flying-insect pest repellent fragrance-containing composition in one elastomer molded body, assuming that the weight of the product is in the range of about 2 to 10 g.

The flying-insect pest repellent product of the present invention obtained in this way can be used in indoor areas such as an entrance, a kitchen, a toilet, a living room, and a bedroom, in spaces such as a warehouse or an interior of a car, in a garden, or outdoors by attaching one to five of the products to various sites such as the wrist, ankle, etc., as needed. Thus, the flying-insect pest repellent product exhibits excellent flying-insect pest repellent effects over a predetermined period of time on flying-insect pests, including mosquitoes such as Culex pipiens, Culex pipiens molestus and

Aedes albopictus, gnats, Chironomidaes, flies, fruit flies (drosophilas, Phoridae, etc.), Phlebotominae, clothes moths, and the like. In the case of using an aromatic flying-insect pest repellent fragrance, the initial fragrance tone lasts for a specified period of time without alteration. In addition, because it does not substantially contain any insecticidal components, even those who do not like the use of insecticides can use it without any hesitation. This makes the aromatic flying-insect pest repellent fragrance extremely practical.

Next, the absorption promotor of the present invention and the flying-insect pest repellent product using the flying-insect pest repellent fragrance-containing composition in which this absorption promotor is blended will be described in more detail based on specific examples, but the present invention is not limited to these.

### EXAMPLES

### Example 1

A flying-insect pest repellent fragrance-containing composition containing an absorption promotor of the present invention was prepared by blending the following components, based on the entire amount of the flying-insect pest repellent fragrance-containing composition (30 mg per silicone rubber molded body): 23.5% by mass (7.1 mg) of d-limonene as the absorption promotor into the silicone rubber molded body; 12.8% by mass (3.8 mg) of benzyl acetate and 4.1% by mass (1.2 mg) of tricyclodecenyl acetate as acetate compounds represented by the general formula (I), which were the components (a) in the flying-insect pest repellent fragrance; 6.7% by mass (2.0 mg) of allyl heptanoate as an allyl ester compound represented by the general formula (II), which was the component (a); 14.0% by mass (4.2 mg) of dihydromyrcenol and 7.6% by mass (2.3 mg) of geraniol as the monoterpene-based alcohol and/or aromatic alcohol having 10 carbon atoms, which are the components (b); 14.6% by mass (4.4 mg) of other flying-insect pest repellent fragrances (including 6.0% by mass of β-pinene and 8.6% by mass of benzyl benzoate); and further 16.7% by mass (5.0 mg)) of dipropylene glycol as the repellent effect persistence component. The blending ratio of the components (a) to the components (b) in this flying-insect pest repellent fragrance-containing composition is 1.09 times.

One hundred silicone rubber molded bodies (hardness of 35 degrees) having a cord and ring shape were prepared using a silicone compound and then placed in a sealed container equipped with a spraying device. The above-mentioned flying-insect pest repellent fragrance-containing composition was sprayed onto the silicone rubber molded bodies using the spraying device such that its adsorption amount was 30 mg per silicone rubber molded body (25.0 mg as the flying-insect pest repellent fragrance). After sufficiently stirring, the flying-insect pest repellent fragrance-containing composition rapidly penetrated the entire silicone rubber molded bodies until 15 hours elapsed, thereby obtaining a flying-insect pest repellent product of the present invention in the form of a wrist ring and having an effective duration of about 10 hours. The average volatilization amount per entire surface area of flying-insect pest repellent fragrance in this flying-insect pest repellent product was 0.34 mg/cm²·h (from the start of use to 2 hours later), and about 42% of the wrist ring was separated from the skin of the wrist when it was worn on the wrist.

When a user wore two of the above-mentioned wrist rings around each wrist and carried them outdoors, the practical repellent effect was confirmed over about ten hours without being bothered by flying-insect pests such as mosquitoes and fruit flies. In addition, the user could enjoy the playfulness by wearing the product with the animal characters and could also enjoy the pleasant freshness of the fragrance that wafted while keeping the initial fragrance tone in a space around the user's body. Aside from this, a similar test was conducted on a silicone rubber molded body having a hardness of 80 degrees, but the flying-insect pest repellent fragrance-containing composition was only slightly adsorbed therein and could not be applied to the present invention.

### Examples 2 to 13 and Comparative Examples 1 to 4

A silicone rubber molded body [length: 20 cm, weight: 3.2 g, and ratio (S₁/S₂) of the total area (S₁) occupied by the hollow to the entire area (S₂) of the silicone rubber molded body: 0.29] was molded using a silicone compound by connecting seven parts having a star-like shape as a hollow outline to constitute a band-shaped body and then providing a binding part at both ends of the band-shaped body (one end having six circular through holes (receptacles) and the other end having T-shaped projections). The hardness of the silicone rubber molded body was adjusted to 31 degrees for each of Examples 2 to 13 and Comparative Examples 1 to 3, and to 62 degrees for Comparative Example 4.

Then, 90 mg of each of the flying-insect pest repellent fragrance-containing compositions shown in Tables 1 and 2, prepared in accordance with Example 1, was injected and added into one site on the outer surface of the silicone rubber molded body, thereby obtaining a flying-insect pest repellent product. Evaluation tests were conducted on the product for items (1) to (4) below. The results obtained are shown in Table 3.
(1) The liquid-absorption performance of the flying-insect pest repellent fragrance-containing composition into the silicone rubber molded body was evaluated by the following method.
(2) After the flying-insect pest repellent product was sealed and stored at 30° C. for six months, the recovery ratio of the flying-insect pest repellent fragrance was determined.
(3) A flying-insect pest repellent effect test was conducted in accordance with the following method.
(4) A volatilization amount measurement test of the flying-insect pest repellent fragrance was conducted in accordance with the following method.

### [Liquid-Absorption Performance Evaluation Test of Flying-Insect Pest Repellent Fragrance-Containing Composition]

The same silicone compound as the above-mentioned silicone rubber molded body was used to prepare a disk-shaped sheet (of about 1 g) with a thickness of about 2 mm and a diameter of 24 mm for the evaluation test. The sheet was placed in a glass petri dish, and one drop of 20 mg of the sample composition was dripped onto the center of the sheet. The petri dish was covered with a lid and stored at 25° C. Then, the time taken for the sample composition in a liquid state to be almost completely absorbed into the sheet was measured. The evaluation was made based on the following criteria.

Level 5: Liquid-absorption time of six hours or more and less than eight hours

Level 4: Liquid-absorption time of eight hours or more and less than 10 hours

Level 3: Liquid-absorption time of 10 hours or more and less than 15 hours

Level 2: Liquid-absorption time of 15 hours or more and less than 24 hours

Level 1: Liquid-absorption time of 24 hours or more

### [Recovery Test of Flying-Insect Pest Repellent Fragrance]

A predetermined amount of flying-insect pest repellent product was sealed in a glass bottle and stored at 30° C. for six months. After returning to room temperature, a flying-insect pest repellent fragrance was extracted from the flying-insect pest repellent product by adding acetone to the glass bottle. The content of the flying-insect pest repellent fragrance was analyzed by gas chromatography for the extracted liquid, and the recovery rate of the flying-insect pest repellent fragrance with respect to the prepared amount thereof was determined.

### [Flying-Insect Pest Repellent Effect Test]

Two open plastic cups (of about 1 L) with no lids were placed in a test chamber (of about 6 m³). One of the plastic cups contained an attractant for adult Culex pipiens and a sample flying-insect pest repellent product (treated section), while the other plastic cup contained only an attractant for adult Culex pipiens (untreated section). About 50 adult Culex pipiens (♀) were released into the room after two and seven hours of the start of use. Then, the numbers of insects invading both sections of the plastic cups were counted, followed by calculating the flying-insect pest repellent ratio in accordance with the following formula.

Flying-insect pest repellent ratio=[(Number of insects invading the untreated section−Number of insects invading the treated section]/[Number of insects invading the untreated section]×100

### [Volatilization Amount Measurement Test of Flying-Insect Pest Repellent Fragrance]

The weight of the flying-insect pest repellent product was measured at the start of use and after two and seven hours of the start of use. Based on decreases in the weight, the average volatilization amount of flying-insect pest repellent fragrance per unit surface area and unit time was calculated for a period of time from the start of use to two hours after the start of use, as well as for a period of time from two hours to seven hours after the start of use.

TABLE 1

| | | | Flying-insect pest repellent fragrance-containing composition (% by mass) | | | | | | | | | | | |
|---|---|---|---|---|---|---|---|---|---|---|---|---|---|---|
| | | | | Flying-insect pest repellent fragrance | | | | | | | | | Repellant | |
| | | | | Component (a) | | | | | | | | | effect | |
| | | Absorption | | Acetate | | Allyl ester | | Component | | Other fragrance | | | persistence | |
| | | promotor | | compound | | compound | | (b) | | components | | (a)/(b) | component | |
| Exam- | 2 | d-Limonene | 23.5 | Benzyl acetate | 12.8 | Allyl | 6.7 | Dihydro- | 14.0 | β-Pinene | 6.0 | 1.09 | Dipropylene | 16.7 |
| ples | | | | | | heptanoate | | myrcenol | | | | | glycol | |
| | | | | Tricyclodecenyl | 4.1 | | | Geraniol | 7.6 | Benzyl | 8.6 | | | |
| | | | | acetate | | | | | | benzoate | | | | |
| | 3 | d-Limonene | 8.2 | Benzyl acetate | 12.8 | Allyl | 6.7 | Dihydro- | 14.0 | β-Pinene | 21.3 | 1.09 | Dipropylene | 16.7 |
| | | | | | | heptanoate | | myrcenol | | | | | glycol | |
| | | | | Tricyclodecenyl | 4.1 | | | Geraniol | 7.6 | Benzyl | 8.6 | | | |
| | | | | acetate | | | | | | benzoate | | | | |
| | 4 | d-Limonene | 3.4 | Benzyl acetate | 12.8 | Allyl | 6.7 | Dihydro- | 14.0 | β-Pinene | 26.1 | 1.09 | Dipropylene | 16.7 |
| | | | | | | heptanoate | | myrcenol | | | | | glycol | |
| | | | | Tricyclodecenyl | 4.1 | | | Geraniol | 7.6 | Benzyl | 8.6 | | | |
| | | | | acetate | | | | | | benzoate | | | | |
| | 5 | d-Limonene | 42.1 | Benzyl acetate | 10.8 | Allyl | 6.7 | Dihydro- | 12.0 | — | | 1.10 | Dipropylene | 16.7 |
| | | | | | | heptanoate | | myrcenol | | | | | glycol | |
| | | | | Tricyclodecenyl | 4.1 | | | Geraniol | 7.6 | | | | | |
| | | | | acetate | | | | | | | | | | |
| | 6 | d-Limonene | 23.5 | Benzyl acetate | 12.8 | — | | Dihydro- | 14.0 | β-Pinene | 12.7 | 0.78 | Dipropylene | 16.7 |
| | | | | | | | | myrcenol | | | | | glycol | |
| | | | | Tricyclodecenyl | 4.1 | | | Geraniol | 7.6 | Benzyl | 8.6 | | | |
| | | acetate | | | | | | benzoate | | | | | | |
| | 7 | d-Limonene | 23.5 | Benzyl acetate | 19.2 | Allyl | 8.0 | Dihydro- | 8.4 | β-Pinene | 4.8 | 2.57 | Dipropylene | 16.7 |
| | | | | | | heptanoate | | myrcenol | | | | | glycol | |
| | | | | Tricyclodecenyl | 6.2 | | | Geraniol | 4.6 | Benzyl | 8.6 | | | |
| | | | | acetate | | | | | | benzoate | | | | |
| | 8 | d-Limonene | 23.5 | Benzyl acetate | 12.8 | Allyl | 6.7 | Dihydro- | 14.0 | β-Pinene | 22.7 | 1.09 | — | |
| | | | | | | heptanoate | | myrcenol | | | | | | |
| | | | | Tricyclodecenyl | 4.1 | | | Geraniol | 7.6 | Benzyl | 8.6 | | | |
| | | | | acetate | | | | | | benzoate | | | | |
| | 9 | 1,8-Cineole | 14.9 | Styralyl acetate | 13.7 | Allyl | 5.3 | Terpineol | 10.5 | Vanillin | 13.8 | 1.41 | 1,3-Butylene | 20.0 |
| | | | | | | hexanoate | | | | | | | glycol | |
| | | | | Menthyl acetate | 7.4 | | | Linalool | 8.2 | Jasmine | 6.2 | | | |
| | | | | | | | | | | lactone | | | | |
| | 10 | 1,8-Cineole | 3.6 | Styralyl acetate | 3.0 | Allyl | 1.4 | Terpineol | 21.4 | Vanillin | 25.1 | 0.17 | 1,3-Butylene | 20.0 |
| | | | | | | hexanoate | | | | | | | glycol | |
| | | | | Menthyl acetate | 2.3 | | | Linalool | 17.7 | Jasmine | 5.5 | | | |
| | | | | | | | | | | lactone | | | | |

| | | | | | | | | | | | | |
|---|---|---|---|---|---|---|---|---|---|---|---|---|
| 11 | 1,8-Cineole | 36.9 | Styralyl acetate | 12.7 | Allyl | 5.3 | Terpineol | 9.5 | — | 1.44 | 1,3-Butylene | 20.0 |
| | | | | | hexanoate | | | | | | glycol | |

| | | | |
|---|---|---|---|
| Menthyl acetate | 7.4 | Linalool | 8.2 |

| | | | | | | | | | | | | |
|---|---|---|---|---|---|---|---|---|---|---|---|---|
| 12 | 1,8-Cineole | 14.9 | Styralyl acetate | 13.7 | Allyl | 5.3 | Terpineol | 10.5 | Vanillin | 33.8 | 1.41 | — |
| | | | | | hexanoate | | | | | | | |

| | | | | | |
|---|---|---|---|---|---|
| Menthyl acetate | 7.4 | Linalool | 8.2 | Jasmine | 6.2 |
| | | | | lactone | |

| | | | | | | | | | | | | |
|---|---|---|---|---|---|---|---|---|---|---|---|---|
| 13 | 1,8-Cineole | 57.2 | Styralyl acetate | 8.7 | Allyl | 3.5 | Terpineol | 6.3 | — | 1.48 | 1,3-Butylene | 15.0 |
| | | | | | hexanoate | | | | | | glycol | |

| | | | |
|---|---|---|---|
| Menthyl acetate | 4.4 | Linalool | 4.9 |

TABLE 2

| | | Flying-insect pest repellent fragrance-containing composition (% by mass) | | | | | | | | | | | | |
|---|---|---|---|---|---|---|---|---|---|---|---|---|---|---|
| | | | | Flying-insect pest repellent fragrance | | | | | | | | | Repellant | |
| | | | | Component (a) | | | | | | | | | effect | |
| | | Absorption | | Acetate | | Allyl ester | | Component | | Other fragrance | | | persistence | |
| | | promotor | | compound | | compound | | (b) | | components | | (a)/(b) | component | |
| Compar- | 1 | — | | Benzyl | 12.8 | Allyl | 6.7 | Dihydromyrcenol | 14.0 | β-Pinene | 29.5 | 1.09 | Dipropylene | 16.7 |
| ative | | | | acetate | | heptanoate | | | | | | | glycol | |
| Examples | | | | Tricyclo- | 4.1 | | | Geraniol | 7.6 | Benzyl | 8.6 | | | |
| | | | | decenyl | | | | | | benzoate | | | | |
| | | | | acetate | | | | | | | | | | |
| | 2 | — | | Styralyl | 13.7 | Allyl | 5.3 | Terpineol | 10.5 | Vanillin | 28.7 | 1.41 | 1,3-Butyene | 20.0 |
| | | | | acetate | | hexanoate | | | | | | | glycol | |
| | | | | Menthyl | 7.4 | | | Linalool | 8.2 | Jasmine | 6.2 | | | |
| | | | | acetate | | | | | | lactone | | | | |
| | 3 | Xylen | 23.5 | Benzyl | 12.8 | Allyl | 6.7 | Dihydromyrcenol | 14.0 | β-Pinene | 6.0 | 1.09 | Dipropylene | 16.7 |
| | | | | acetate | | heptanoate | | | | | | | glycol | |
| | | | | Tricyclo- | 4.1 | | | Geraniol | 7.6 | Benzyl | 8.6 | | | |
| | | | | decenyl | | | | | | benzoate | | | | |
| | | | | acetate | | | | | | | | | | |
| | 4* | 1,8- | 14.9 | Styralyl | 13.7 | Allyl | 5.3 | Terpineol | 10.5 | Vanillin | 13.8 | 1.41 | 1,3-Butylene | 20.0 |
| | | Cineole | | acetate | | hexanoate | | | | | | | glycol | |
| | | | | Menthyl | 7.4 | | | Linalool | 8.2 | Jasmine | 6.2 | | | |
| | | | | acetate | | | | | | lactone | | | | |

*Silicone rubber molded body having hardness of 62 degrees was used

TABLE 3

| | | | Recovery | | | | |
|---|---|---|---|---|---|---|---|
| | | Liquid- | ratio | Flying-insect pest | | Average | |
| | | absorption | of fragrance | repellent ratio | | volatilization | |
| | | performance | component | (%) | | amount (mg/cm² · h) | |
| | | level | (%) | After 2 h | After 7 h | 0~2 h | 2~7 h |
| Examples | 2 | 4~5 | 100 | 100 | 100 | 0.41 | 0.36 |
| | 3 | 4 | 98 | 96 | 93 | 0.37 | 0.31 |
| | 4 | 2~3 | 95 | 90 | 84 | 0.34 | 0.29 |
| | 5 | 5 | 99 | 97 | 92 | 0.38 | 0.32 |
| | 6 | 4~5 | 99 | 91 | 85 | 0.39 | 0.31 |
| | 7 | 4~5 | 98 | 92 | 84 | 0.38 | 0.30 |
| | 8 | 4~5 | 98 | 96 | 82 | 0.37 | 0.23 |
| | 9 | 4~5 | 100 | 100 | 97 | 0.40 | 0.36 |
| | 10 | 2~3 | 94 | 90 | 83 | 0.34 | 0.28 |
| | 11 | 5 | 98 | 95 | 91 | 0.37 | 0.32 |
| | 12 | 4~5 | 98 | 96 | 81 | 0.36 | 0.24 |
| | 13 | 5 | 97 | 96 | 83 | 0.39 | 0.28 |
| Comparative | 1 | 1 | 92 | 89 | 76 | 0.30 | 0.15 |
| Examples | 2 | 1 | 91 | 87 | 74 | 0.28 | 0.16 |
| | 3 | 4 | 89 | 83 | 69 | 0.25 | 0.13 |
| | 4 | 1~2 | 90 | 57 | 38 | 0.12 | 0.05 |

As a result of the tests, it was confirmed that in Examples 2 to 13, the absorption promotor of the present invention into the silicone rubber modified body, i.e., d-limonene and/or 1,8-cineole blended in the flying-insect pest repellent fragrance-containing composition together with the flying-insect pest repellent fragrance, could accelerate the liquid-absorption rate of the flying-insect pest repellent fragrance-containing composition into the silicone rubber molded body, and contribute to the efficiency of a necessary manufacturing process. Meanwhile, it was also confirmed that the obtained flying-insect pest repellent products had improved quality in a storage state, and exhibited excellent volatilization performance of the flying-insect pest repellent fragrance and satisfactory flying-insect pest repellent effects after two and seven hours of the start of use.

A composition (Example 4-2) was prepared by changing the content of d-limonene from 3.4% by mass to 2.5% by mass and also changing the content of benzylbenzoate from 8.6% by mass to 9.5% by mass in the flying-insect pest repellent fragrance-containing composition of Example 4 with the contents of other flying-insect pest repellent fragrance components left unchanged. This composition exhibited the absorption performance level, the recovery ratio of fragrance components, the flying-insect pest repellent ratio, and the average volatilization amount which are at the same levels as those in Example 4.

Further, citronella oil (made in China: 2.6% by mass of d-limonene, 34.4% by mass of citronellal, 24.9% by mass of geraniol, 13.6% by mass of citronellyl acetate and geranyl acetate, and other components) was tested as a flying-insect pest repellent fragrance-containing composition. When compared to Example 4 and Example 4-2, the absorption performance and the recovery ratio of the fragrance components of the citronella oil were almost the same as those of Examples 4 and 4-2, and the flying-insect pest repellent ratio and average volatilization amount thereof were not so different from those of Examples 4 and 4-2.

Furthermore, ghetto oil (16.6% by mass of 1,8-cineole, 11.5% by mass of terpinen-4-ol, and 7.3% by mass of β-pinene, and other components) was tested as a flying-insect pest repellent fragrance-containing composition. When compared to Example 12, the absorption performance and the recovery ratio of the fragrance components of the ghetto oil were almost the same as those of Example 12, and the flying-insect pest repellent ratio and average volatilization amount thereof were not so different from those of Example 12.

Thus, it was confirmed that d-limonene and/or 1,8-cineole both were effective as the absorption promotor, regardless of whether they were derived from essential oils or blended as individual components.

As the flying-insect pest repellent fragrance, a combination of three components, namely, an acetate compound represented by the general formula (I), which was the component (a), an allyl ester compound represented by the general formula (II), which was the component (a), and a monoterpene-based alcohol and/or an aromatic alcohol having 10 carbon atoms, which was the component (b), was the most preferable, and the more excellent flying-insect pest repellent effect was obtained when the ratio of the component (a) to the component (b) was in the range of 0.2 to 2.0. Furthermore, in Examples 2 to 7 and 9 to 11, the blending of the repellent effect persistence component was effective in suppressing the reduction of the flying-insect pest repellent effect in the later stages of use. In contrast, as shown in

Comparative Examples 1 and 2, when the absorption promotor of the present invention was not blended, the liquid-absorption rate into the silicone rubber molded body in the flying-insect pest repellent fragrance-containing composition became slow, and as a result, there was a risk of decomposition and deterioration of a certain kind of flying-insect pest repellent fragrance on the surface of the silicone rubber molded body, and the flying-insect pest repellent effect in use also became inferior. In Comparative Example 3 in which xylene was used instead of the absorption promoter of the present invention, the liquid-absorption rate became faster, and the silicone rubber molded body was clearly embrittled and unsuitable when compared to Example 2. Furthermore, it was confirmed that as in comparative example 4, when the hardness of the silicone rubber molded body exceeded 60 degrees even in the use of the absorption promoter of the present invention, the liquid-absorption performance was at level 1 to 2, and the flying-insect pest repellent fragrance was difficult to volatilize from the rubber molded body, so that the flying-insect pest repellent effect in use became noticeably inferior.

Next, instead of the silicone rubber molded body having a hardness of 31 degrees and used in Example 2, the above-mentioned liquid-absorption performance evaluation test was conducted using silicone rubber molded bodies having different hardnesses of 48 degrees, 55 degrees, and 60 degrees. As a result, in the silicone rubber molded body having a hardness of 48 degrees, the liquid-absorption performance was at level 4 to 5, while in the silicone rubber molded bodies having different hardnesses of 55 degrees and 60 degrees, the liquid-absorption performance was at level 3 to 4. From these results, it was confirmed that the hardness of the silicone rubber molded body was preferably 60 degrees or less, and more preferably 50 degrees or less.

### Example 14

A flying-insect pest repellent fragrance-containing composition containing an absorption promotor of the present invention was prepared by blending the following components, based on the entire amount of the flying-insect pest repellent fragrance-containing composition (30 mg per silicone rubber molded body): 15.8% by mass (4.7 mg) of 1,8-cineole as the absorption promotor into the silicon rubber molded body; 10.5% by mass (3.2 mg) of citronellyl acetate and 5.6% by mass (1.7 mg) of p-tert-butylcyclohexyl acetate as acetate compounds, represented by the general formula (I), which were the components (a) in the flying-insect pest repellent fragrance; 7.3% by mass (2.2 mg) of allyl octanoate as an allyl ester compound represented by the general formula (II) which was the component (a); 14.9% by mass (4.5 mg) of menthol and 9.1% by mass (2.7 mg) of thymol as the monoterpene-based alcohol and/or aromatic alcohol having 10 carbon atoms, which were the components (b); 20.1% by mass (6.0 mg) of other flying-insect pest repellent fragrances (including 13.7% by mass of lemongrass oil and 6.4% by mass of benzyl benzoate); and 16.7% by mass (5.0 mg) of dipropylene glycol as a repellent effect persistence component. The blending ratio of the component (a) to the component (b) in the flying-insect pest repellent fragrance-containing composition was 0.98 times.

A two-component additive liquid silicone rubber composition was cured to form a small piece sheet-shaped silicone rubber molded body (diameter: 3 cm, thickness: 1.2 mm, hardness: 37 degrees, surface area on one side: 7.1 cm²).

On the other hand, 30 mg of the above-mentioned flying-insect pest repellent fragrance-containing composition (25 mg as the flying-insect pest repellent fragrance) was injected and added into one site on the surface of the obtained silicone rubber molded body, and the composition was then left under a sealed condition for one day, thereby causing the flying-insect pest repellent fragrance-containing composition to uniformly penetrate the entire silicone rubber molded body.

This was stored in a plastic storage body [a body obtained by integrally forming a front side portion and a rear side portion via a hinge portion, each of the front and rear side portions being ring-shaped (diameter: 3.5 cm) and including a circular hole (diameter: 2.7 cm) in its center] to thereby obtain a flying-insect pest repellent product of the present invention for the interior of a vehicle with an effective duration of about 10 hours.

When this product was used while being hung inside the vehicle, the average volatilization amount of flying-insect pest repellent fragrance was 0.28 mg/cm²·h for a period of time from the start of use to five hours of use, which could prevent flying-insect pests such as mosquitoes, fruit flies, and the like from invading the interior of the vehicle over about 10 hours.

A composition (Example 14-2) was prepared by changing 15.8% by mass (4.7 mg) of 1,8-cineole to 3.7% by mass (1.1 mg) of d-limonene and 12.1% by mass (3.6 mg) of 1,8-cineole as the absorption promotor in the flying-insect pest repellent fragrance-containing composition of Example 14 with the other components left unchanged. This composition was absorbed into the silicon rubber molded body as rapidly as in Example 14 and also exhibited the average volatilization amount and the flying-insect pest repellent effect which were at the same levels as those in Example 14.

### Examples 15 to 22 and Comparative Examples 5 to 9

A flying-insect pest repellent fragrance-containing composition shown in Table 4 was prepared using a band-shaped thermoplastic elastomer molded body (width: 12 mm, length: 20 cm, thickness: 1.0 mm, weight: 3.0 to 3.5 g) in accordance with Example 1. Then, 100 mg of this composition was injected and added into one site on the outer surface of the thermoplastic elastomer molded body, thereby obtaining a flying-insect pest repellent product.

After the flying-insect pest repellent products were sealed and stored at 30° C. for six months, the recovery ratio of the flying-insect pest repellent fragrance was determined. In addition, the above-mentioned liquid-absorption performance evaluation test, the flying-insect pest repellent effect test, and the volatilization amount measurement test were conducted on these flying-insect pest repellent products. The results obtained are shown in Table 5.

TABLE 4

| | | | Flying-insect pest repellent fragrance-containing composition (% by mass) | | | | | | | |
|---|---|---|---|---|---|---|---|---|---|---|
| | | Thermo- | | | Flying-insect pest repellent fragrance | | | | | |
| | | plastic | | | Component (a) | | | | | |
| | | elastomer | | | | | Allyl | | | |
| | | (Hardness: | Absorption | | Acetate | | ester | | Component | |
| | | degree) | promotor | | compound | | compound | | (b) | |
| Examples | 15 | SEBS | d- | 18.5 | Linalyl | 15.2 | Allyl | 7.1 | Citronellol | 12.9 |
| | | (41) | Limonene | | acetate | | cyclohexyl | | | |
| | | | | | Phenylethyl | 3.8 | propionate | | Eugenol | 8.4 |
| | | | | | acetate | | | | | |
| | 16 | SEBS | d- | 18.5 | Linalyl | 15.2 | Allyl | 7.1 | Citronellol | 12.9 |
| | | (41) | Limonene | | acetate | | cyclohexy | | | |
| | | | | | Phenylethyl | 3.8 | propionate | | Eugenol | 8.4 |
| | | | | | acetate | | | | | |
| | 17 | SEBS | d- | 18.5 | Linalyl | 15.2 | Allyl | 7.1 | Citronellol | 12.9 |
| | | (56) | Limonene | | acetate | | cyclohexyl | | | |
| | | | | | Phenylethyl | 3.8 | propionate | | Eugenol | 8.4 |
| | | | | | acetate | | | | | |
| | 18 | SEBS | 1,8- | 20.3 | Benzyl | 11.6 | Allyl | 6.0 | Geraniol | 18.5 |
| | | (41) | cineole | | acetate | | heptanoate | | | |
| | | | | | Terpinyl | 4.7 | | | Ethyl | 7.6 |
| | | | | | acetate | | | | linalool | |
| | 19 | TPO-V | d- | 18.5 | Linalyl | 15.2 | Allyl | 7.1 | Citronellol | 12.9 |
| | | (36) | Limonene | | acetate | | cyclohexyl | | | |
| | | | | | | | propionate | | | |
| | | | | | Phenylethyl | 3.8 | | | Eugenol | 8.4 |
| | | | | | acetate | | | | | |
| | 20 | TPO | 1,8- | 20.3 | Benzyl | 11.6 | Allyl | 6.0 | Geraniol | 18.5 |
| | | (36) | cineole | | acetate | | heptanoate | | | |
| | | | | | Terpinyl | 4.7 | | | Ethyl | 7.6 |
| | | | | | acetate | | | | linalool | |
| | 21 | TPEE | 1,8- | 24.9 | Phenylethyl | 12.4 | Allyl | 5.3 | Menthol | 15.7 |
| | | (40) | cineole | | acetate | | octanoate | | | |
| | | | | | Neryl | 5.0 | | | Borneol | 9.2 |
| | | | | | acetate | | | | | |
| | 22 | TPO | 1,8- | 49.3 | Benzyl | 8.5 | Allyl | 3.7 | Geraniol | 12.1 |
| | | (36) | cineole | | acetate | | heptanoate | | | |
| | | | | | Terpinyl | 3.8 | | | Ethyl | 5.9 |
| | | | | | acetate | | | | linalool | |
| Comparative | 5 | SEBS | — | | Linalyl | 15.2 | Allyl | 7.1 | Citronellol | 12.9 |
| Examples | | (41) | | | acetate | | cyclohexyl | | | |
| | | | | | | | propionate | | | |
| | | | | | Phenylethyl | 3.8 | | | Eugenol | 8.4 |
| | | | | | acetate | | | | | |
| | 6 | TPO | — | | Benzyl | 11.6 | Allyl | 6.0 | Geraniol | 18.5 |
| | | (36) | | | acetate | | heptanoate | | | |
| | | | | | Terpinyl | 4.7 | | | Ethyl | 7.6 |
| | | | | | acetate | | | | linalool | |
| | 7 | TPEE | — | | Phenylethyl | 12.4 | Allyl | 5.3 | Menthol | 15.7 |
| | | (40) | | | acetate | | octanoate | | | |
| | | | | | Neryl | 5.0 | | | Borneol | 9.2 |
| | | | | | acetate | | | | | |
| | 8 | SEBS | d- | 18.5 | Linalyl | 15.2 | Allyl | 7.1 | Citronellol | 12.9 |
| | | (62) | Limonene | | acetate | | cyclohexyl | | | |
| | | | | | Phenylethyl | 3.8 | propionate | | Eugenol | 8.4 |
| | | | | | acetate | | | | | |
| | 9 | TPO | 1,8- | 20.3 | Benzyl | 11.6 | Allyl | 6.0 | Geraniol | 18.5 |
| | | (63) | cineole | | acetate | | heptanoate | | | |
| | | | | | Terpinyl | 4.7 | | | Ethyl | 7.6 |
| | | | | | acetate | | | | linalool | |

| | | Flying-insect pest repellent fragrance | | | Repellant | |
|---|---|---|---|---|---|---|
| | | Other | | | effect | |
| | | fragrance | | | persistence | |
| | | components | | (a)/(b) | component | |
| Examples | 15 | Pulegone | 12.4 | 1.22 | Dipropylene | 16.7 |
| | | | | | glycol | |
| | | Diphenyl | 5.0 | | | |
| | | oxide | | | | |
| | 16 | Pulegone | 12.4 | 1.22 | — | |
| | | Diphenyl | 21.7 | | | |
| | | oxide | | | | |
| | 17 | Pulegone | 12.4 | 1.22 | — | |
| | | Diphenyl | 21.7 | | | |
| | | oxide | | | | |
| | 18 | Carvone | 11.0 | 0.85 | Dipropylene | 16.7 |
| | | | | | glycol | |
| | | Lemongrass | 3.6 | | | |
| | | oil | | | | |
| | 19 | Pulegone | 12.4 | 1.22 | Dipropylene | 16.7 |
| | | | | | glycol | |
| | | Diphenyl | | | | |
| | | oxide | 5.0 | | | |
| | 20 | Carvone | 11.0 | 0.85 | Dipropylene | 16.7 |
| | | | | | glycol | |
| | | Lemongrass | 3.6 | | | |
| | | oil | | | | |
| | 21 | Damascone | 7.5 | 0.91 | Dipropylene | 16.7 |
| | | | | | glycol | |
| | | Eucalyptus | 3.3 | | | |
| | | oil | | | | |
| | 22 | — | | 0.89 | Dipropylene | 16.7 |
| | | | | | glycol | |
| Comparative | 5 | Pulegone | 12.4 | 1.22 | Dipropylene | 16.7 |
| Examples | | | | | glycol | |
| | | Diphenyl | 23.5 | | | |
| | | oxide | | | | |
| | 6 | Carvone | 27.1 | 0.85 | Dipropylene | 16.7 |
| | | | | | glycol | |
| | | Lemongrass | 7.8 | | | |
| | | oil | | | | |
| | 7 | Damascone | 24.5 | 0.91 | Dipropylene | 16.7 |
| | | | | | glycol | |
| | | Eucalyptus | 11.2 | | | |
| | | oil | | | | |
| | 8 | Pulegone | 12.4 | 1.22 | Dipropylene | 16.7 |
| | | | | | glycol | |
| | | Diphenyl | 5.0 | | | |
| | | oxide | | | | |
| | 9 | Carvone | 11.0 | 0.85 | Dipropylene | 16.7 |
| | | | | | glycol | |
| | | Lemongrass | 3.6 | | | |
| | | oil | | | | |

TABLE 5

| | | | Recovery | | | | |
|---|---|---|---|---|---|---|---|
| | | Liquid- | ratio | | | | |
| | | absorption | of fragrance | Flying-insect pest | | Average volatilization | |
| | | performance | component | repellent ratio (%) | | amount (mg/cm² · h) | |
| | | level | (%) | After 2 h | After 7 h | 0~2 h | 2~7 h |
| Examples | 15 | 3~4 | 94 | 92 | 84 | 0.34 | 0.28 |
| | 16 | 3~4 | 93 | 90 | 79 | 0.31 | 0.20 |
| | 17 | 3 | 91 | 89 | 77 | 0.28 | 0.19 |
| | 18 | 3~4 | 94 | 91 | 85 | 0.30 | 0.26 |
| | 19 | 3~4 | 95 | 90 | 84 | 0.33 | 0.27 |
| | 20 | 3~4 | 94 | 91 | 83 | 0.31 | 0.25 |
| | 21 | 4~5 | 95 | 88 | 80 | 0.24 | 0.15 |
| | 22 | 5 | 95 | 94 | 80 | 0.33 | 0.20 |
| Comparative | 5 | 1 | 85 | 80 | 65 | 0.20 | 0.09 |
| Examples | 6 | 1 | 87 | 82 | 68 | 0.22 | 0.11 |
| | 7 | 1~2 | 86 | 79 | 61 | 0.18 | 0.07 |
| | 8 | 1~2 | 87 | 60 | 37 | 0.12 | 0.06 |
| | 9 | 1~2 | 86 | 56 | 35 | 0.11 | 0.04 |

Results of the tests in Examples 15 to 22 regarding the absorption promotor of the present invention for the thermoplastic elastomer molded body, i.e., d-limonene and/or 1,8-cineole blended in the flying-insect pest repellent fragrance-containing composition together with the flying-insect pest repellent fragrance, confirmed the followings: the absorption promotor could accelerate the liquid-absorption rate of the flying-insect pest repellent fragrance-containing composition into the thermoplastic elastomer molded body; the absorption promotor contributed to the efficiency of a necessary manufacturing process, as in the silicone rubber molded bodies of Examples 2 to 13; the obtained flying-insect pest repellent products had improved quality in a storage state as the product; the products exhibited excellent volatilization performance of the flying-insect pest repellent fragrance as well as satisfactory flying-insect pest repellent effects, after two and seven hours of the start of use.

From the comparison between Example 16 and Example 17, it was found that the hardness of the thermoplastic elastomer molded body used in the present invention was preferred to be less than 50 degrees rather than the range of 50 to 60 degrees in order to obtain good liquid-absorption performance. Furthermore, from the comparison between Example 15 and Example 16, the blending of the repellent effect persistence component was effective in suppressing the reduction of the flying-insect pest repellent effect in the later stages of use.

In contrast, as shown in Comparative Examples 5 to 7, when the absorption promotor of the present invention was not blended, the liquid-absorption rate of the flying-insect pest repellent fragrance-containing composition into the thermoplastic elastomer molded body became slow, and as a result, there was a risk of decomposition and deterioration of a certain kind of flying-insect pest repellent fragrance on the surface of the thermoplastic elastomer molded body, and the flying-insect pest repellent effect in use also became inferior. Furthermore, it was confirmed that as in Comparative Examples 8 and 9, when the hardness of the thermoplastic elastomer molded body exceeded 60 degrees even in the use of the absorption promoter of the present invention, the liquid-absorption performance was at level 1 to 2, and the flying-insect pest repellent fragrance was difficult to volatilize from the thermoplastic elastomer molded body, so that the flying-insect pest repellent effect in use became noticeably inferior.

Among the materials of the thermoplastic elastomer molded body, SEBS, TPO, and TPO-V were preferable. However, when comparing Examples 2 to 13 using silicone rubber molded bodies with Examples 15 to 22 using thermoplastic elastomer molded bodies, it was confirmed that the silicone rubber molded body was generally superior to the thermoplastic elastomer molded body in terms of the performances, such as the adsorption and dispersion, of the flying-insect pest repellent fragrance-containing composition for the silicone rubber molded body and the thermoplastic elastomer molded body.

### INDUSTRIAL APPLICABILITY

The absorption promotor into the elastomer molded body, the flying-insect pest repellent fragrance-containing composition, and the flying-insect pest repellent product using the flying-insect pest repellent fragrance-containing composition according to the present invention can be utilized not only for flying-insect pests, but also for a wide range of insect pest control purposes.

1. An absorption promotor for causing a flying-insect pest repellent fragrance-containing composition to be absorbed into an elastomer molded body having a hardness of 60 degrees or less, comprising
d-limonene and/or 1,8-cineole as an active ingredient.

2. The absorption promotor of claim 1, wherein the elastomer molded body is a silicon rubber molded body.

3. The absorption promotor of claim 1, wherein the elastomer molded body is a thermoplastic elastomer molded body.

4. The absorption promotor of claim 3, wherein the thermoplastic elastomer molded body is a styrene-based thermoplastic elastomer molded body or an olefin-based thermoplastic elastomer molded body.

5. The absorption promotor of claim 1, wherein the absorption promotor is blended in a range of 2.0 to 65% by mass in the flying-insect pest repellent fragrance-containing composition.

6. The absorption promotor of claim 5, wherein the absorption promotor is blended in a range of 10 to 45% by mass in the flying-insect pest repellent fragrance-containing composition.

7. The absorption promotor of claim 1, wherein the flying-insect pest repellent fragrance-containing composition contains the following component (a) and component (b),
the component (a) being an acetate compound as a single substance or a mixture, represented by general formula (I) below,
CH₃—COO—R1 (I)
wherein R1 is an alcohol residue having 6 to 12 carbons,
the component (b) being a monoterpene-based alcohol and/or an aromatic alcohol having 10 carbon atoms.

8. The absorption promotor of claim 7, wherein the component (a) is at least one selected from the acetate compound and an allyl ester compound as a single substrate or a mixture, represented by general formula (II) below,
R2—CH₂—COO—CH₂—CH═CH₂ (II)
wherein R2 is an alkyl, alkoxy, cycloalkyl, cycloalkoxy, or phenoxy group having 4 to 7 carbon atoms.

9. The absorption promotor of claim 7, wherein a blending ratio of the component (a) to the component (b) in the flying-insect pest repellent fragrance-containing composition is set in a range of 0.2 to 2.0 times.

10. The absorption promotor of claim 7, wherein the acetate compound is at least one selected from the group consisting of: p-tert-butylcyclohexyl acetate, o-tert-butylcyclohexyl acetate, p-tert-pentylcyclohexyl acetate, tricyclodecenyl acetate, benzyl acetate, phenylethyl acetate, styralyl acetate, anisyl acetate, menthyl acetate, cinnamyl acetate, terpinyl acetate, dihydroterpinyl acetate, linalyl acetate, ethyl linalyl acetate, citronellyl acetate, geranyl acetate, neryl acetate, bornyl acetate, and isobornyl acetate.

11. The absorption promotor of claim 8, wherein the allyl ester compound is at least one selected from the group consisting of allyl hexanoate, allyl heptanoate, allyl octanoate, allyl n-amyl oxyacetate, allyl cyclohexyl acetate, allyl cyclohexyl oxyacetate, and allyl phenoxyacetate.

12. The absorption promotor of claim 7, wherein the monoterpene-based alcohol and/or the aromatic alcohol having 10 carbon atoms is at least one selected from the group consisting of terpineol, geraniol, dihydromyrcenol, borneol, menthol, citronellol, nerol, linalool, ethyl linalool, thymol, eugenol, and p-menthane-3,8-diol.

13. The absorption promotor of claim 7, wherein the flying-insect pest repellent fragrance-containing composition further contains a glycol and/or a glycol ether having a vapor pressure of 0.2 to 20 Pa at 20° C., as a repellant effect persistence component when a flying-insect pest repellent fragrance is volatilized.

14. The absorption promotor of claim 13, wherein the glycol and/or the glycol ether is at least one selected from the group consisting of benzyl glycol, propylene glycol, dipropylene glycol, tripropylene glycol, 1,3-butylene glycol, hexylene glycol, diethylene glycol monobutyl ether, dipropylene glycol monobutyl ether, and tripropylene glycol monomethyl ether.

15. A flying-insect pest repellent fragrance-containing composition, comprising: a component (a) and a component (b); and d-limonene and/or 1,8-cineole,
the component (a) being an acetate compound as a single substance or a mixture, represented by general formula (I) below,
CH₃—COO—R1 (I)
wherein R1 is an alcohol residue having 6 to 12 carbons,
the component (b) being a monoterpene-based alcohol and/or an aromatic alcohol having 10 carbon atoms.

16. The flying-insect pest repellent fragrance-containing composition of claim 15, wherein
the component (a) is at least one selected from the acetate compound and an allyl ester compound as a single substrate or a mixture, represented by general formula (II) below,
R2—CH₂—COO—CH₂—CH═CH₂ (II)
wherein R2 is an alkyl, alkoxy, cycloalkyl, cycloalkoxy, or phenoxy group having 4 to 7 carbon atoms.

17. A flying-insect pest repellent product, comprising a flying-insect pest repellent fragrance-containing composition in which the absorption promotor according to claim 1 is blended, the flying-insect pest repellent fragrance-containing composition being held on an elastomer molded body while being embedded in interstices of a molecular structure of the elastomer molded body, the elastomer molded body having a hardness of 60 degrees or less.

18. The flying-insect pest repellent product of claim 17, wherein the elastomer molded body having the hardness of 60 degrees or less is configured such that a flying-insect pest repellent fragrance is volatilized from a surface of the elastomer molded body at a rate (average volatilization amount per unit surface area) of 0.04 to 0.9 mg/cm²·h.

19. The flying-insect pest repellent product of claim 17, wherein the elastomer molded body having the hardness of 60 degrees or less is a ring-shaped elastomer molded body that includes a stretchable ring-shaped portion which a part of a human body or an object is inserted into or attached to, or a band-shaped elastomer molded body which is capable of forming a stretchable ring-shaped portion by connecting or proximating ends and which a part of a human body or an object is inserted into or attached to.

20. The flying-insect pest repellent product of claim 19, wherein the flying-insect pest repellent fragrance is volatilized over 5 to 15 hours while the part of the human body or object is inserted into or attached to the ring-shaped portion.
